(19) United States
(12) Patent Application Publication
(10) Pub. No.: US 2026/0253408 A1
(43) Pub. Date: Aug. 27, 2026

(54) MULTITASK PERCEPTION WITH CONFIDENCE MEASURES

(71) Applicant: QUALCOMM Incorporated, San Diego, CA (US)

(72) Inventors: Upal MAHBUB, El Cajon, CA (US); Gokce DANE, San Diego, CA (US)

(21) Appl. No.: 19/061,491

(22) Filed: Feb. 24, 2025

(51) Int. Cl. G06V 10/96; G06V 10/52; G06V 10/72; G06V 10/764; G06V 10/77; G06V 10/776; G06V 10/82; G06V 20/70

(52) U.S. Cl. CPC G06V 10/96; G06V 10/764; G06V 10/7715; G06V 10/776; G06V 10/82; G06V 20/70; G06V 10/52; G06V 10/72

(57) ABSTRACT

Certain aspects of the present disclosure provide techniques for performing multitask perception tasks, including receiving an input; receiving contextual information associated with the input; generating a shared feature representation based on the input and the contextual information; applying a first task-specific output head to the shared feature representation to generate a first task-specific output corresponding to a first task and a first confidence measure indicating an accuracy of the first task-specific output; and applying a second task-specific output head to the shared feature representation to generate a second task-specific output corresponding to a second task and a second confidence measure indicating an accuracy of the second task-specific output.

### INTRODUCTION

### Field of the Disclosure

Aspects of the present disclosure relate to perception tasks, and more particularly, to techniques for multitask perception.

### DESCRIPTION OF RELATED ART

In computer vision and scene understanding applications, some systems may perform various perception tasks such as depth estimation, semantic segmentation, and object detection to understand properties of the environment. For example, depth estimation may determine distances to surfaces in a captured scene, semantic segmentation may classify image regions into object categories, and object detection may locate and identify objects of interest. In some aspects, these perception tasks may operate on the same input data, such as image frames captured by cameras on extended reality (XR) devices, robots, or mobile devices. In some aspects, each perception task may extract different types of information to understand various aspects of the scene. For instance, depth estimation may generate depth maps showing three-dimensional geometry, semantic segmentation may generate masks identifying object regions and classes, and object detection may output bounding boxes that localize objects.

In some aspects, dedicated machine learning models may be used for each individual perception task. That is, a separate machine learning model processes the input data to generate outputs specific to that task. Each machine learning model may maintain its own set of learned parameters and may require dedicated computational resources during inference. When deploying computer vision capabilities to resource-constrained devices like mobile phones or XR headsets, factors such as computational efficiency, power consumption, and latency may impact the overall deployment. That is, having multiple separate models running in parallel may strain system resources.

### SUMMARY

One aspect provides a method for performing multitask perception tasks. In some aspects, the method may include receiving an input; receiving contextual information associated with the input; generating a shared feature representation based on the input and the contextual information; applying a first task-specific output head to the shared feature representation to generate a first task-specific output corresponding to a first task and a first confidence measure indicating an accuracy of the first task-specific output; and applying a second task-specific output head to the shared feature representation to generate a second task-specific output corresponding to a second task and a second confidence measure indicating an accuracy of the second task-specific output.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example system for performing multitask perception using a shared feature representation and one or more task-specific output heads in accordance with aspects of the present disclosure.

FIG. 2 depicts an example multitask perception model in accordance with aspects of the present disclosure.

FIG. 3 depicts an example system for obtaining pseudo-contextual information in accordance with aspects of the present disclosure.

FIG. 4 depicts an example training process for training a system to generate multiple task-specific outputs and associated confidence measures in accordance with aspects of the present disclosure.

FIG. 5 depicts a diagram illustrating an example AI architecture that may be used to implement a multitask perception technique in accordance with aspects of the present disclosure.

FIG. 6 depicts an example AI architecture of a first device that is in communication with a second device, in accordance with examples of the present disclosure.

FIG. 7 illustrates an example artificial neural network, in accordance with examples of the present disclosure.

FIG. 8 depicts a method for performing multitask perception using a shared feature representation and one or more task-specific output heads in accordance with aspects of the present disclosure.

FIG. 9 depicts aspects of an example processing system for performing multitask perception using a shared feature representation and one or more task-specific output heads in accordance with aspects of the present disclosure.

### DETAILED DESCRIPTION

Aspects of the present disclosure provide apparatuses, methods, processing systems, and computer-readable mediums for performing multitask perception using a shared feature representation and one or more task-specific output heads.

In computer vision systems, efficiently and reliably extracting multiple types of information from a single input may be challenging. For example, in some aspects, given an image frame captured by a camera on an extended reality (XR) headset, a robot, or a mobile device, various perception tasks may be required to understand the scene. In some aspects, a perception task may refer to an operation performed on input data, such as an image, to produce an interpretable output that provides insight into one or more aspects of an environment. In some aspects, an environment may refer to a data domain from which input is derived. For example, an environment may refer to the spatial setting captured by a camera, an acoustic space recorded by a microphone, or a textual domain represented by a corpus of documents. In some aspects, a perception task may include generating depth maps that reveal three-dimensional geometry, producing semantic segmentation masks that identify and classify objects or regions, detecting objects or features, estimating object poses, or determining other scene attributes. In some cases, these different perception tasks may be performed by separate specialized machine learning models, each with its own computational pipeline and resources. In some aspects, having a separate machine learning model for each perception task may be inefficient, especially in embedded devices where computational constraints, power consumption, and latency are important considerations.

Such as to address these challenges, aspects of the present disclosure are directed to techniques for performing multiple perception tasks using a shared feature representation and multiple task-specific output heads to generate multiple task-specific outputs. In some aspects, a perception task may refer to an operation that processes input data, such as an image or sensor reading, to extract meaningful information about a physical environment. In some aspects, such information may be, for example, depths, objects categories, and/or spatial relationships. In some aspects, a task-specific output head may include a computational component, such as neural network layers or operations configured to process shared features, configured to perform a perception task and generate corresponding outputs that represent estimates about properties of an environment or scene. These outputs may include, for example, a depth map that estimates distances to surfaces in a scene, a segmentation mask that classifies regions into object categories, a set of object detection bounding boxes that localizes objects, or another form of scene-related output tailored to a particular perceptual objective. In some aspects, the task-specific outputs may be based on a received input and received contextual information associated with the input. In some aspects, an input may refer to data acquired from one or more sensors, cameras, or other input devices, such as image data, point cloud data, acoustic waveforms, a textual question, or other forms of data. In some aspects, contextual information may refer to parameters, seed values such as sparse inverse depth measurements at selected pixel locations, partial ground truth data such as human-annotated depth values for a subset of pixels, or pseudo-contextual information such as predictions from pre-trained models, that provide constraints, initial estimates, or additional guidance for determining at least one task-specific output. For example, contextual information could represent known depth values at certain locations for an input, approximate object boundaries, or historical conditions that influence the interpretation of the input. In some aspects, contextual information may be sparse in that only a limited subset or fraction of the total available data points are provided rather than a complete dense set. In some aspects, contextual information may refer to pseudo-contextual information corresponding to data derived from an external model's predictions or estimations rather than human-annotated ground truth.

In some aspects, together with the input and the contextual information, the multiple task-specific outputs may be based on contextual validation information. In some aspects, contextual validation information may refer to additional data or signals that verify, confirm, or refine certain aspects of the provided contextual information. In some aspects, contextual validation information may indicate which portions of the contextual information are considered trustworthy or reliable, provide metrics for data quality, or identify points where previously provided parameters may be uncertain or invalid. For example, a validation mask may specify which reference depth values (e.g., depth seeds) in the contextual information are considered accurate reference points for depth estimation. In some aspects, the validated reference depth values (e.g., validated depth seeds) may be considered reliable reference measurements that guide the generation of task-specific outputs by providing known depth values at specific pixel locations. In some aspects, contextual validation information may also include heuristic checks, statistical tests, or external quality assessments that confirm the fidelity of pseudo-contextual information. Contextual validation information may improve the stability and accuracy of a task-specific output.

In some aspects, the input, the contextual information, and in some aspects, the contextual validation information may be processed by a shared backbone network. In some aspects, a shared backbone network may refer to a foundational model architecture that receives raw input data and associated signals (e.g., including contextual and validation information) and transforms them into a set of intermediate features that are expressive and informative across multiple perception tasks. In some aspects, the shared backbone network may include layers of learnable parameters that progressively extract patterns, edges, textures, shapes, semantic cues, and structural relationships from the data. Rather than training separate networks for each perception task, the shared backbone network can be trained to learn a representation that may support multiple perception tasks simultaneously. In some aspects, the shared backbone network can reduce computational redundancy and memory overhead, as the same features may be reused for different perception tasks. In some aspects, because the shared backbone network is shared among tasks, improvements in one perception task's performance can indirectly enhance the feature representations for other tasks and increase an overall system efficiency and accuracy.

In some aspects, the output of the shared backbone network may be processed by a shared feature fusion component. In some aspects, a shared feature fusion component may integrate, combine, or reconcile features extracted at different resolutions, scales, and abstraction levels by the shared backbone network. In some aspects, multiscale features may refer to feature sets obtained across different spatial resolutions and abstraction levels, capturing fine-grained details and high-level semantic information. In some aspects, multiscale features may refer to the aggregation of features from early network layers which capture fine spatial details, and deeper network layers that capture semantic and contextual clues. For example, in some aspects, low-level features may capture fine-grained details such as edges or corners, while high-level features may represent semantic concepts like object categories. In some aspects, the shared feature fusion component merges these multiscale features into a representation that preserves local detail where necessary and retains an overall understanding of the scene. In some aspects, techniques such as feature pyramids, skip connections, or attention mechanisms may be used.

In some aspects, the shared feature fusion component may output a shared multiscale feature representation. In some aspects, the shared multiscale feature representation may be a structured set of features capturing high-level semantic information and lower-level spatial details. In some aspects, the shared multiscale feature representation may be organized such that each component of the feature set corresponds to a particular resolution or spatial scale. For example, in some aspects, a segmentation perception task may depend on boundary delineations from a high-resolution scale. In contrast, in some aspects, a depth prediction perception task may use more global structural patterns from a coarser scale.

In some aspects, a task-specific perception head including one or more task-specific output heads may be applied to the shared multiscale feature representation. In some aspects, the one or more task-specific output heads may refer to specialized computational modules, which may be implemented as additional neural network layers or sub-networks. In some aspects, one or more task-specific output heads may generate outputs for a particular perception task. In some aspects, each task-specific output head may receive the shared multiscale feature representation as input and apply one or more functions or operations specific to a perception task. For example, a task-specific output head may predict per-pixel depth values. In some aspects, a task-specific output head may classify pixels into semantic categories. In some aspects, a task-specific output head may detect object locations or key points. In some aspects, task-specific logic is maintained as separate individual task-specific output heads. Perception tasks may be added, removed, or refined without altering the underlying shared backbone network or shared multiscale feature representation. In some aspects, training can be tailored for each perception task, such that training strategies can be modified and loss functions or optimization parameters can be separately configured.

In some aspects, one or more task-specific output heads may generate outputs corresponding to a perception task, along with associated confidence measures. In some aspects, a confidence measure may refer to an indication or score that represents how certain the system is about the correctness or accuracy of a given prediction. For example, a depth estimation task-specific head may generate a dense depth map and a per-pixel confidence score indicating the accuracy of each depth value. A segmentation task-specific output head may output class labels for each pixel and a confidence measure reflecting how certain the model is about those labels. Another task-specific output head may generate object detection bounding boxes and assign confidence values to indicate the likelihood that a detected object exists in that region. By providing confidence measures, the task-specific output heads enable downstream systems or decision-making modules to adaptively trust, filter, or refine the results. For instance, areas of low confidence can be identified for further verification, additional processing, or alternative sensing modalities.

In some aspects, pseudo-contextual information may refer to data samples for which labels are not obtained through direct human annotation but are generated by another model's predictions or estimations. In some aspects, pseudo-contextual information may be noisy, incomplete, or mismatched to the target domain. For example, in some aspects, mismatched pseudo-contextual information may occur when a segmentation model trained on outdoor scenes (e.g., streets and cars) is applied to indoor images (e.g., rooms and furniture), causing a model to label chairs as vehicles or fail to recognize indoor walls as valid structures. In some aspects, the pseudo-contextual information may be used by one or more of the shared backbone network, the shared feature fusion component, or a task-specific perception head to facilitate training certain tasks without manually obtained ground truth labels. For example, a semantic segmentation perception task, may not have comprehensive ground-truth annotations for every image. In some aspects, a pre-trained, off-the-shelf segmentation model may generate pseudo-labeled masks. Although these pseudo labels may be imperfect, integrating them alongside a more reliable first task, such as depth estimation using seed data, and adjusting their influence may provide stability during a joint training process.

Such as to address challenges associated with training a system that integrates multiple perception tasks, contextual information, and confidence measures, in some aspects, a joint training process may be employed. In some aspects, during joint training, one or more of the shared backbone network, the shared feature fusion component, and/or the task-specific output heads may be updated together by combining losses resulting from multiple perception tasks. For example, losses may include depth losses computed at the seed points of contextual data or segmentation losses derived from ground truth or pseudo-labeled masks. In some aspects, the losses may include an inter-task consistency loss that encourages alignment between the outputs of different perception tasks, allowing improvements in one task's predictions (e.g., refined segmentation boundaries) to guide and enhance another task's estimates (e.g., smoother depth transitions at object edges). In some aspects, the loss functions may use confidence predictions so that more confident outputs may be weighted higher and uncertain outputs may be weighted lower.

In some aspects, the techniques discussed herein provide certain advantages. For example, by integrating multiple perception tasks into a single framework, a system may efficiently use computational resources. Such an approach may reduce the need for separately running individual models, lowering memory consumption, shortening inference times, and decreasing power usage. Additionally, the shared backbone network and shared multiscale feature representation may allow tasks to benefit from one another's learned features, improving accuracy in resource-constrained environments.

### Example System for Performing Multitask Perception

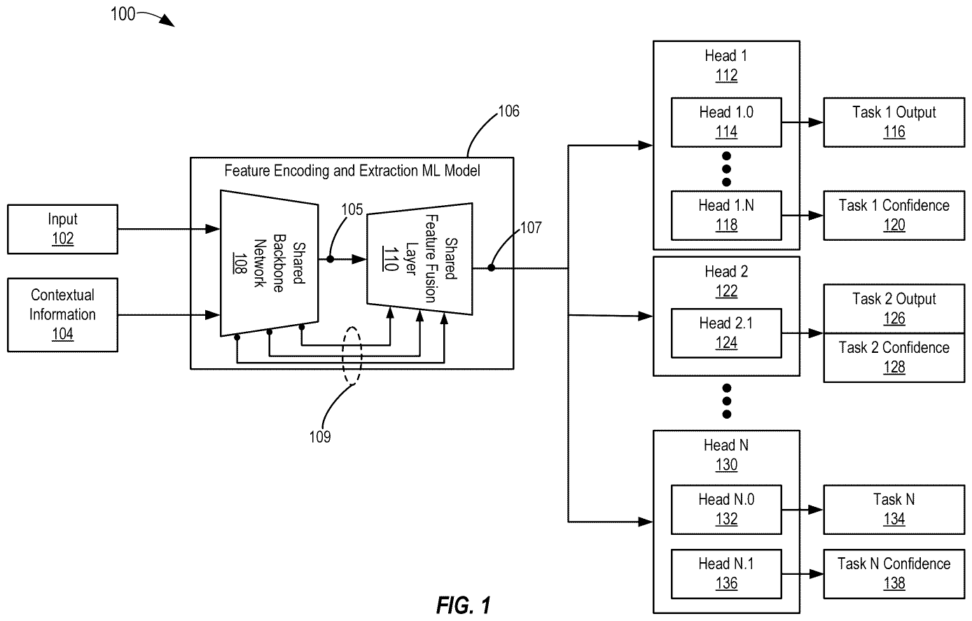

FIG. 1 depicts an example system 100 for performing multitask perception using a shared multiscale feature representation and one or more task-specific output heads in accordance with aspects of the present disclosure. In some aspects, the system 100, or portions thereof, may be implemented by an apparatus, a processing system, methods, or non-transitory computer-readable mediums.

In some aspects, the system 100 may receive an input 102 and contextual information 104. In some aspects, the input 102 may comprise data acquired from one or more sensors or other input devices, such as image data, point cloud data, audio data, or textual data. In some aspects, the contextual information 104 may include parameters, such as sensor calibration values or environmental constraints, seed values such as sparse inverse depth points that provide reference depth information at specific pixels, partial ground truth data such as annotated segmentation masks or object labels, pseudo-contextual information derived from model-generated approximations, or additional signals providing guidance, constraints, or initial estimates for one or more perception tasks. For example, sparse inverse depth points may be derived from depth sensors or stereo imaging and used to scale and anchor depth predictions. In some aspects, anchor may refer to providing fixed reference points that a system can utilize to align and stabilize an overall depth estimation, which may help to increase accuracy and consistency of a predicted result. In some aspects, the contextual information 104 may be associated with the input 102 and may be used to generate at least one task-specific output.

In some aspects, the input 102 and contextual information 104 may be received by a feature encoding and extraction ML model 106. In some aspects, the feature encoding and extraction ML model 106 may be configured to generate a shared multiscale feature representation 107 from the input 102 and contextual information 104. In some aspects, the feature encoding and extraction ML model 106 may include a shared backbone network 108 and a shared feature fusion component 110. In some aspects, the shared backbone network 108 may refer to a foundational model architecture that learns representations from the input 102 and contextual information 104. For example, the shared backbone network 108 may be a trained classification model, such as a ResNet-34 architecture, adapted to extract features. In some aspects, the shared backbone network 108 may be trained to learn and represent features that support multiple perception tasks. In some aspects, the shared feature fusion component 110 may include one or more layers or components that integrate extracted features across varying spatial resolutions, scales, and/or abstraction levels. For example, the shared feature fusion component 110 may utilize feature pyramids, skip connections, and/or attention mechanisms to merge features from different layers of the shared backbone network 108 into a multiscale representation. In some aspects, the shared backbone network 108 may output extracted features 109 and the final encoder output 105 to the shared feature fusion component 110.

In some aspects, the shared feature fusion component 110 may receive the extracted features 109 and integrate the extracted features 109 across multiple scales and abstraction levels. For example, features derived from earlier layers of the shared backbone network 108 may capture fine spatial details like edges and textures, while features derived from deeper layers may encode higher-level semantic concepts such as object categories or scene context. In some aspects, by combining these distinct feature sets, the shared feature fusion component 110 may create a representation that leverages both fine-grained, high-resolution information and more abstract, low-resolution semantic cues. In some aspects, the shared feature fusion component 110 may apply techniques, such as feature pyramids, skip connections, or attention mechanisms, to generate the shared multiscale feature representation 107 used by multiple task-specific output heads.

In some aspects, one or more task-specific perception heads may be applied to the multiscale feature representation 107 to generate task-specific outputs. In some aspects, each task-specific perception head may correspond to a particular perception task, such as depth estimation, semantic segmentation, object detection, or other scene understanding operation.

In some aspects, a first task-specific perception head 112 is implemented. In some aspects, the first task-specific perception head 112 may include a first task-specific output head 114 configured to generate a first output 116 for the first perception task. In some aspects, the first output 116 may be a task-specific output such as inverse depth values.

In some aspects, the first task-specific perception head 112 may include X (e.g., where X is an integer) task-specific output heads, such as further include a second task-specific output head 118. In some aspects, the second task-specific output head 118 may generate a second output 120 associated with the first perception task. In some aspects, the second output 120 may comprise a confidence measure, indicating an accuracy or reliability assessment for the first output 116. For example, if the first output 116 is an inverse depth map, the second output 120 may provide pixel-wise or region-based confidence scores that allow downstream modules to selectively trust, filter, or reweight certain depth predictions.

In some aspects, a second task-specific perception head 122 may include a first task-specific output head 124 configured to generate a first output 126 for the second perception task and a second output 128. For example, if the second perception task relates to semantic segmentation, the first output 126 may be a segmentation mask identifying objects or regions within the input 102. In some aspects, the second task-specific perception head 122 may also generate a second output of 128, which may represent a confidence measure for the first output 126. In other words, the second output 128 may quantify the reliability of the segmentation labels. In some aspects, the second output 128 may be used to dynamically adjust thresholds, selectively refine a portion of one or more outputs, or implement error mitigation strategies in response to low-confidence predictions.

In some aspects, additional tasks may be implemented. For example, an Nth task-specific perception head 130 indicates that an arbitrary number of perception tasks may be implemented. In some aspects, each Nth task-specific perception head 130 may include task-specific output head(s) 132 and 136 and associated output 134, including confidence measures 138. Accordingly, additional perception tasks can be implemented without altering the underlying shared backbone network 108 or the shared feature fusion component 110.

### Example Multitask Perception Model

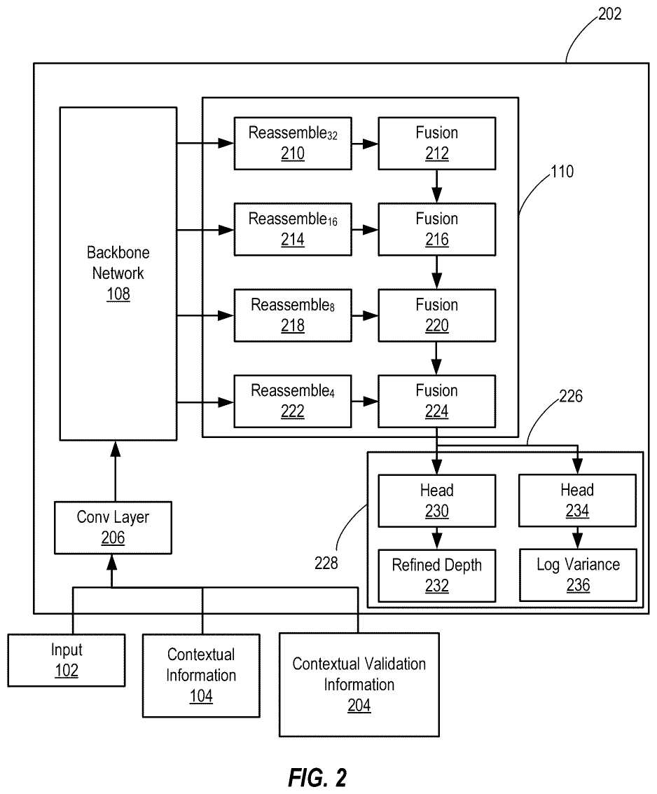

FIG. 2 depicts an example multitask perception model 202 in accordance with aspects of the present disclosure. In some aspects, the example multitask perception model 202 may be configured to process an input 102, contextual information 104, and contextual validation information 204 and generate predictions for one or more perception tasks. In some aspects, the contextual validation information 204 may serve as a quality check or reliability indicator for the contextual information 104. For example, while the contextual information 104 may include approximate or pseudo-contextual information providing initial guidance, the contextual validation information 204 may highlight which portions of this guidance are accurate and are to be weighted more heavily, and which portions are uncertain or potentially incorrect and should be down-weighted or ignored. In some aspects, the contextual validation information 204 may be a binary mask where each pixel indicates whether a corresponding depth value in the contextual information 104 is reliable (e.g., marked as “1”) or unreliable (e.g., marked as “0”). In some aspects, using the contextual validation information 204 may allow the multitask perception model 202 to utilize more reliable contextual cues when generating its outputs.

In some aspects, the example multitask perception model 202 may include a convolution layer 206 that receives the input 102 and contextual information 104. In some aspects, the convolution layer 206 may perform initial feature extraction, normalizing or transforming input 102 and contextual information 104 into a representation that is more amenable to downstream processing. For example, this may involve converting raw pixel intensities or sparse depth points into a structured feature map that emphasizes useful patterns (e.g., edges, gradients, or object contours), making it easier for subsequent layers to interpret and leverage these patterns without having to account for noisy or unprocessed raw data. In some aspects, the output of the convolution layer 206 may be provided to a shared backbone network 108. As previously described, the shared backbone network 108 may be configured to learn a common set of features supportive of multiple perception tasks. In some aspects, the shared backbone network 108 may be implemented using a model architecture such as a ResNet-34, adapted to extract features from one or more inputs (e.g., input 102, contextual information 104, contextual validation information 204). By processing the input 102 and contextual information 104 through the shared backbone network 108, the example multitask perception model 202 may reduce computational overhead and reuse learned representations.

In some aspects, contextual validation information 204 may also be input to the example multitask perception model 202. In some aspects, the contextual validation information 204 may influence how certain features are weighted or filtered by providing reliability metrics or binary indicators for specific contextual elements, such as depth seeds. In some aspects, depth seeds may refer to sparse reference depth values obtained from contextual information 104, such as from depth sensors, stereo imaging, or annotated ground truth data. For example, if certain depth seeds are identified in the contextual validation information 204 as accurate and verified, the example multitask perception model 202 can prioritize these seeds when constructing depth predictions, Alternatively, or in addition, depth seeds or pseudo-contextual information identified as unreliable in the contextual validation information 204 may be weighted less heavily or ignored. By selecting among and prioritizing elements of the contextual information 104 based on contextual validation information 204, the example multitask perception model 202 can improve the accuracy and stability of the resulting outputs.

In some aspects, a sequence of operations following the shared backbone network 108 may generate a shared multiscale feature representation 226. The shared multiscale feature representation 226 may be generated in part by reassembly blocks and fusion blocks arranged across multiple scales. In some aspects, multiple scales may refer to different spatial resolutions or levels of detail. For example, at coarser scales, features may represent large scene structures (e.g., broad shapes, object placements), while at finer scales, features may capture detailed information (e.g., object edges, textures, small contours). As another example, the reassemble₃₂ 210 and fusion layer 212 may operate at a particular resolution level (e.g., a coarse resolution) using techniques such a bilinear interpolation to align feature maps. Similarly, reassemble₁₆ 214 and fusion layer 216, reassemble₈ 218 and fusion layer 220, and reassemble₄ 222 and fusion layer 224 may progressively refine and combine features at increasingly finer spatial scales using techniques such as, but not limited to, pyramid pooling, skip connections, and/or attention mechanisms. In some aspects, each reassemble element, such as reassemble₃₂ 210, reassemble₁₆ 214, reassemble 218, and reassemble₄ 222, may reorganize or align features extracted from the shared backbone network 108 into a consistent spatial format. In some aspects, a consistent spatial format may refer to arranging feature maps so that all pixels or feature vectors correspond to the same physical region of the input, allowing subsequent layers to combine information across different resolutions without misalignments or gaps. In some aspects, the reassembly operations (e.g., reassemble₃₂ 210, reassemble₁₆ 214, reassemble₈ 218, and reassemble₄ 222) may merge or blend information from different layers, resolutions, or receptive fields, using techniques such as, but not limited to, concatenation, additive merging, and/or self-attention, to generate a multiscale representation.

In some aspects, each fusion operation, such as fusion layer 212, fusion layer 216, fusion layer 220, and fusion layer 224, may integrate the reassembled features across various resolution scales. In some aspects, the various resolution scales may bring combine coarse, global features (representing large patterns or object layouts) with finer, high-resolution details (capturing more precise boundaries, textures, and local structures), resulting in a representation that includes large patterns and local detail. In some aspects, the fusion blocks may implement techniques such as additive merging, concatenation, attention mechanisms, or learned transformations that merge multiscale information. In some aspects, by implementing multiple stages of reassembly and fusion processes, the multitask perception model 202 may generate a final shared multiscale feature representation 226 at the output of fusion layer 224. This shared multiscale feature representation 226 may then be provided to one or more task-specific perception heads to generate refined predictions for various perception tasks.

As depicted in FIG. 2, a task-specific perception head 228 may be applied to the output of the final fusion layer 224, where the output of the final fusion layer 224 may correspond to the shared multiscale feature representation 226. In some aspects, the task-specific perception head 228, which may include a task-specific output head 230 as described in FIG. 1, may be configured to produce a refined depth 232 as output. In some aspects, the refined depth 232 may correspond to a depth map that is corrected, scaled, or otherwise improved based on the shared multiscale feature representation 226, contextual information 104, and any applicable contextual validation information 204. For example, the task-specific output head 230 may integrate sparse depth seeds provided as contextual information. Sparse depth seeds may refer to reference points containing known depth values at specific locations in an input image. In some aspects, the sparse depth seeds may be obtained from sources such as depth sensors, stereo cameras, or annotated data. In some aspects, the sparse depth seeds may be used as fixed anchors to scale and refine a depth map prediction. In some aspects, the task-specific output head 230 may align depth estimates with segmentation boundaries learned by another task, or utilize confidence measures to discard uncertain pixels. By providing a refined depth 232 output, the multitask perception model 202 may enhance scene understanding and improve the accuracy of downstream operations, such as 3D reconstruction or object localization.

In some aspects, the task-specific perception head 228 may include a task-specific output head 234 that operates in parallel or subsequent to the task-specific output head 230. The task-specific output head 234 may be configured to generate a log variance 236 as output, where the log variance 236 may represent a measure of uncertainty or confidence in the corresponding refined depth 232 predictions. In some aspects, the log variance 236 may encode pixel-wise inconsistencies in the depth estimation, allowing downstream processes to interpret and respond to low-confidence regions differently than high-confidence regions. For example, areas of high variance may signal that the multitask perception model 202 is less certain about depth predictions. In some aspects, corrective actions may be taken, such as additional processing, filtering operations, or integration with alternative sensing modalities.

### Example System for Obtaining Pseudo-Contextual Information

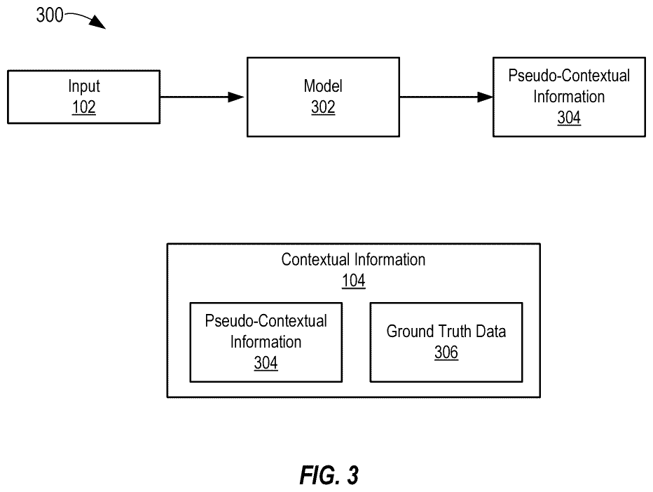

FIG. 3 depicts an example system 300 for obtaining pseudo-contextual information 304 that may be used as part of contextual information 104 in accordance with aspects of the present disclosure. In some aspects, the contextual information 104 may guide or constrain one or more perception tasks performed by a processing system. As previously described, contextual information 104 may include pseudo-contextual information 304 and ground truth data 306.

In some aspects, model 302 may be a model that provides model-generated labels. In some aspects, the model-generated labels may include approximations of object boundaries, object detection proposals, or coarse semantic maps relevant to the perception tasks. For example, a segmentation model could generate rough segmentation masks based on the input 102, thereby providing pseudo-contextual information 304 at minimal annotation cost.

In some aspects, the pseudo-contextual information 304 generated by model 302 may be incorporated into the contextual information 104. In some aspects, the contextual information 104 may include ground truth data 306 alongside the pseudo-contextual information 304. For example, ground truth data 306 may encompass manually annotated depth measurements, human-labeled segmentation masks, known object poses, or other reliable reference information. By combining pseudo-contextual information 304 with ground truth data 306, contextual information 104 may leverage approximate but widely available model-generated labels and highly accurate but potentially sparse or limited ground truth labels. In some aspects, the pseudo-contextual information 304 and/or the ground truth data 306 may be used for one or more inference tasks and/or training tasks, enabling a system to improve performance, adapt to new domains, or refine its internal models using both reliable and approximate ground truth data.

In some aspects, the model 302 may generate the pseudo-contextual information 304 for regions or for perception tasks where ground truth data 306 is unavailable or costly. In some aspects, the available ground truth data 306 may constrain the pseudo-contextual information 304, acting as reference points that prevent inaccuracies in the model-generated labels from destabilizing training or inference operations. For example, if the pseudo-contextual information 304 includes noisy segmentation boundaries for certain objects, relying solely on the pseudo-contextual information 304 during training could cause the network's parameters to drift toward erroneous representations. In some aspects, this may reduce accuracy and consistency in predictions. In some aspects, during inference, unverified pseudo-contextual information 304 may lead a model to misidentify objects or misestimate depth across multiple frames, accumulating errors and degrading performance. By stabilizing these approximations with sparse but more reliable ground truth data 306, a system may be trained in a more stable manner and may provide more reliable inference outcomes. As a result, the contextual information 104, including pseudo-contextual information 304 and/or ground truth data 306, may improve a system's ability to perform various perception tasks more accurately and efficiently.

### Example Training Process

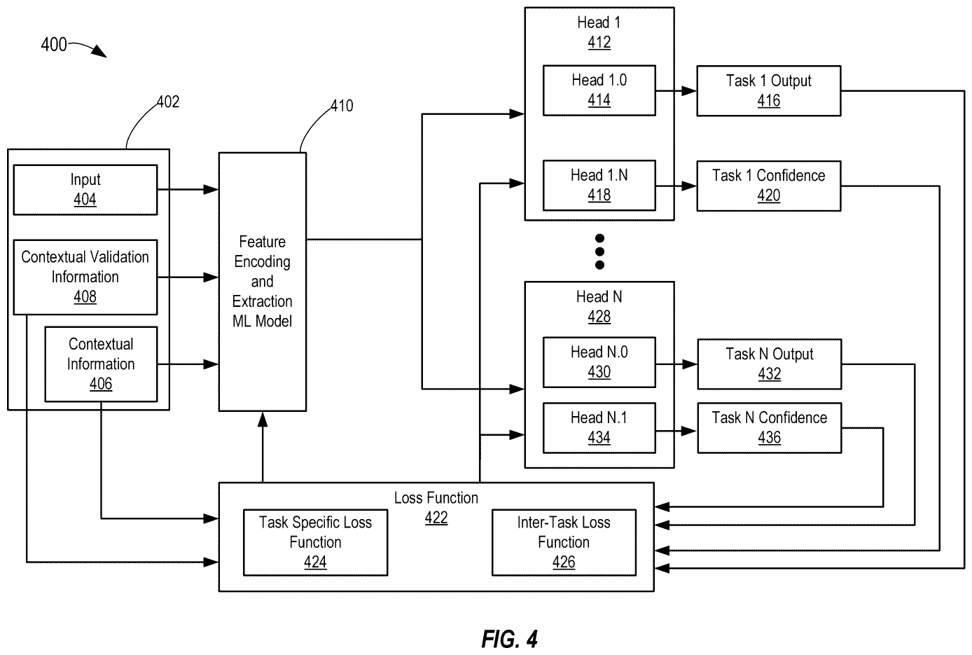

FIG. 4 depicts an example training process 400 for training the system 100 to generate multiple perception task-specific outputs and associated confidence measures in accordance with aspects of the present disclosure. In some aspects, the training process 400 may be implemented by an apparatus, method, or processing system configured to optimize the parameters of one or more models. In some aspects, the parameters of one or more models may refer to the weights, biases, or other learnable variables within neural network layers, feature extraction pipelines, or task-specific heads that are adjusted during training to improve prediction accuracy and generalization.

In some aspects, training data 402 may include input 404, contextual information 406, and contextual validation information 408. In some aspects, the training data may represent a combination of raw sensor inputs, auxiliary guidance signals, and quality checks or validations that enable the model to learn representations for multiple perception tasks. In some aspects, the input 404 may correspond to input 102 (FIG. 1) as previously described. In some aspects, input 404 may include image data, point cloud data, audio waveforms, textual prompts, or any other sensor or recorded modality that might be used to perform scene understanding. In some aspects, contextual information 406 may correspond to contextual information 104 (FIG. 1) as previously described. In some aspects, contextual information 406 may include parameters such as seed depth values, pseudo-labeled segmentation masks, approximate object boundaries, or historical sensor readings that provide supplemental cues beyond the raw input data. In some aspects, contextual validation information 408 may correspond to contextual validation information 204 (FIG. 2) as previously described. In some aspects, the contextual validation information 408 may include validation signals, masks, or indicators that highlight which portions of the contextual information 406 are reliable, trusted, or have been confirmed. Although the training data 402 is depicted as including input 404, contextual information 406, and contextual validation information 408, it should be understood that the training data 402 may include one or more of the input 404, contextual information 406, and contextual validation information 408.

In some aspects, during the training process, the training data 402 may be provided to the feature encoding and extraction ML model 410. The feature encoding and extraction ML model 410 may correspond to the combination of a shared backbone network 108 and a shared feature fusion component 110 as described in FIG. 1. In some aspects, based on the training data 402, the feature encoding and extraction ML model 410 may generate a shared multiscale feature representation that may be used for multiple perception tasks.

In some aspects, the shared multiscale feature representation from the feature encoding and extraction ML model 410 may be provided to a first task-specific perception head 412. In some aspects, the first task-specific perception head 412 may be an untrained or partially trained component at the onset of the training process 400. The first task-specific perception head 412 may include one or more task-specific output heads to generate corresponding task-specific outputs. As depicted in FIG. 4, a first task-specific output head 414 may generate a first output 416 that may correspond to a primary prediction for the first perception task. For example, the first output 416 may be a depth map, segmentation mask, or other per-pixel or per-region prediction indicative of scene content.

The first task-specific perception head 412 may include a second task-specific output head 418 that generates a second output 420. In some aspects, the second output 420 may represent a confidence measure, log variance value, or other uncertainty metric or accuracy metric associated with the first output 416. In some aspects, the training process 400 may leverage confidence-aware training strategies by generating the primary prediction (the first output 416) and associated confidence (the second output 420). For example, a confidence-aware training strategy may assign higher weighting to regions or examples where a model is more confident. In some aspects, a confidence-aware training strategy may guide the learning process to reinforce correct predictions while reducing the impact of uncertain or noisy predictions to prevent the uncertain or noisy predictions from skewing the model's parameters.

In some aspects, to train the parameters of the feature encoding and extraction ML model 410 and the first task-specific perception head 412 and its task-specific output heads 414 and 418, one or more loss functions 422 may be utilized. In some aspects, a loss function 422 may receive the outputs (e.g., 416 and 420) of the output heads (e.g., 414 and 418) and compare them with ground truth annotations, partial labels, pseudo-contextual information, or other target values derived from the contextual information 406 and contextual validation information 408. In some aspects, the loss function 422 may include one or more components. For example, the loss function 422 may include a task-specific loss function. A task-specific loss function 424 may measure how closely the first output 416 matches its corresponding ground truth or reference data. In some aspects, the loss function 422 may include an inter-task loss function 426. The inter-task loss function 426 may encourage consistency between the predictions of different perception tasks so that improving performance in one task can indirectly support better predictions in another. An example of an inter-task loss function 426 may be a segmentation-aware depth smoothness constraint, where accurate segmentation boundaries may help guide depth predictions to become smoother and more realistic around object edges. In some aspects, improvements in segmentation may result in improvements in depth estimation.

In some aspects, the training process 400 may utilize iterative training, such as backpropagation and gradient-based optimization, to update one or more parameters of the feature encoding and extraction ML model 410, the first task-specific perception head 412, and its associated task-specific output heads 414, 418 to minimize the loss as calculated by the loss function 422. In some aspects, the training process 400 may scale to support additional perception tasks beyond the first task-specific perception head 412. In some aspects, an Nth task-specific perception head 428 may represent the capability to introduce, modify, or remove perception tasks as needed without altering the underlying feature encoding and extraction ML model 410. In some aspects, the Nth task-specific perception head 428 may begin in an untrained or partially trained state, and may similarly be trained using the joint training procedure described herein.

The Nth task-specific perception head 428 may include one or more task-specific output heads designed to produce outputs relevant to its particular perception task. For example, a first task-specific output head 430 for the Nth task-specific perception head may generate a first output 432 corresponding to a primary prediction for that new task. Like the first output 416 of the first task-specific output head 414, the first output 432 may represent a range of task-specific predictions, such as detecting certain object classes, estimating camera pose, or identifying surfaces within a scene.

In addition, the Nth task-specific perception head 428 may also include another task-specific output head 434 that produces an Nth output 436 associated with that same task. In some aspects, the Nth output 436 may represent a confidence measure, such as an uncertainty estimation, accuracy, or reliability score for the first output 432, analogous to how the second output 420 provides confidence information for the first perception task.

In some aspects, during training, the Nth task-specific perception head 428 and its task-specific output heads 430 and 434 may be integrated into the joint training process 400. The loss function 422, which may encompass a task-specific loss function 424 and inter-task loss function 426, may incorporate the first output 432 and Nth output 436 from the Nth task-specific perception head 428. In some aspects, the parameters corresponding to the Nth task-specific perception head 428 are updated together with those of the feature encoding and extraction ML model 410 and the first task-specific perception head 412.

In some aspects, when training a system to produce multiple task-specific outputs (e.g., depth estimates, segmentation masks, object detections), the selection and formulation of loss functions are important to achieving stable and accurate results. For example, a depth estimation task may be implemented as one of the perception tasks depicted in FIG. 4. In some aspects, the depth-related losses operating at multiple resolution scales may be applied to improve the quality of the estimated depth. In some aspects, the losses may be combined with other task-specific losses (e.g., segmentation-aware losses) to jointly optimize the model for targeted perception tasks. One such depth estimation framework may utilize losses such as uncertainty-aware distance loss, structural similarity loss, and edge-aware depth smoothness loss. In some example, the uncertainty-aware distance loss may be provided by Equation 1.

$${L}_{Dist} = \frac{\vert μ ( d ) - {d}^{*} \vert}{σ ( d )} + log σ ( d ) = {e}^{( - log σ ( d ) )} \vert μ ( d ) - {d}^{*} \vert + log σ ( d ) \qquad Equation 1$$

In some aspects, μ(d) represents the predicted depth, and d* represents a ground truth depth. In some aspects, log (σ(d)) may be the estimated log-variance of the depth, which may be directly related to the depth confidence score. Using an uncertainty-aware formulation allows a model to express pixel-wise confidence, focusing more on regions where the model can reliably predict depth and less on regions with high uncertainty.

In some aspects, log σ(d) may be the estimate log variance of depth, which may be converted to a depth confidence score using Equation 2.

$$Confidence : C = \frac{1}{σ ( d )} = \frac{1}{{e}^{log σ ( d )}} = {e}^{- log σ ( d )} \qquad Equation 2$$

In some aspects, structural similarity loss may be provided according to Equation 3.

$${L}_{SSIM} = ( 1 - SSIM ( {I}_{a} , {I}_{b} ) ) \qquad Equation 3$$

In some aspects, SSIM (Iₐ, I_{b}) measures the structural similarity between the predicted depth map (or reconstructed image from depth) and a reference image I_{b}. In some aspects, by including structural similarity loss, the model is encouraged to preserve structural consistency and improve the perceptual quality of the depth output.

In some aspects, the edge-aware depth smoothness loss may be provided according to Equation 4.

$${L}_{smooth} = \vert {\partial }_{x} {d}_{t}^{*} \vert {e}^{- \vert {\partial }_{x} {I}_{t} \vert} + \vert {\partial }_{y} {d}_{c}^{*} \vert {e}^{- \vert {\partial }_{y} {I}_{t} \vert} \qquad Equation 4$$

In some aspects, the edge-aware depth smoothness loss encourages smoothness in the predicted depth map. Weighting smoothness by image gradients e^{-|∂}^{ₓ}^{I}^{_{t|}} and e^{-|∂}^{_{y}}^{I}^{_{t|}} can preserve edges where depth changes are expected.

Accordingly, a total depth loss may be provide according to Equation 5.

$${L}_{Depth\_Total} = {w}_{Dist} \times {L}_{Dist} + {w}_{SSIM} \times {L}_{SSIM} + {w}_{smooth} \times {L}_{Smooth} \qquad Equation 5$$

In some aspects, a multitask perception model can estimate depth as μ(d) where the uncertainty

$$log σ ( d ) , {d}_{t}^{*} = \frac{{d}_{t}}{\overline{{d}_{t}}}$$

may be the mean normalized inverse depth to discourage shrinking of estimated depth, and w_{Dist}=100, w_{SSIM}=wₛₘₒₒₜₕ=50.

In some aspects, similar task-specific losses can be introduced for other perception tasks tied to depth estimation. For instance, a semantic or instance segmentation task may add a segmentation-aware depth smoothness loss, where estimated segmentation masks help guide depth smoothness calculations per class. For other tasks like hand detection, depth smoothness loss can be calculated based on one or more hand masks. In some aspects, when performing plane detection, a surface normal regularization loss can be applied to an estimated depth to determine a detected plane.

### Example Artificial Intelligence System for Object Detection

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement Learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as an object detection system in autonomous driving.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

### Example Artificial Intelligence System for Object Detection

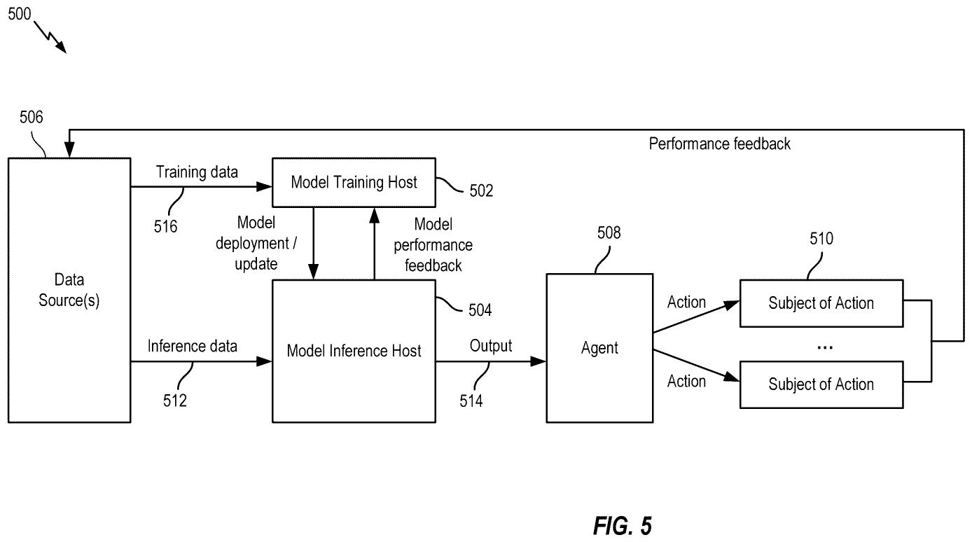

FIG. 5 is a diagram illustrating an example AI architecture 500 that may be used to implement the machine learning models and multitask perception techniques described in this disclosure. As illustrated, the architecture 500 includes multiple logical entities, such as a model training host 502 for training the machine learning model with shared backbone network and task-specific output heads, a model inference host 504 for running inference using the trained model, data source(s) 506 providing training and inference data, and an agent 508 that utilizes the model's output. This AI architecture could be used to enable the example disclosed multitask perception techniques in various machine learning applications.

The model inference host 504, in the architecture 500, is configured to run an ML model based on inference data 512 provided by data source(s) 506. The model inference host 504 may produce an output 514 (e.g., multiple task-specific outputs such as depth maps, segmentation masks, and associated confidence measures) based on the inference data 512, that is then provided as input to the agent 508.

The agent 508 may be an element or entity that utilizes the output of the machine learning model hosted by the model inference host 504. The agent 508 could be a software component, a hardware accelerator, or a system that leverages the task-specific outputs produced by the model for various downstream tasks such as scene understanding, object detection, or semantic segmentation.

For example, if the output 514 from the model inference host 504 includes both depth maps and semantic segmentation masks obtained through the task-specific perception heads, the agent 508 may be an extended reality application that uses both outputs for improved scene understanding. As another example, if the output 514 includes object detection results and associated confidence measures, the agent 508 could be a robotics navigation system.

After receiving the output 514 from the model inference host 504, the agent 508 may determine how to utilize it. For instance, if the agent 508 is an extended reality app and the outputs include both depth and segmentation information, it may use the combined information to place virtual objects with proper occlusion and semantic understanding. If the agent 508 decides to use the output 514, it may apply it to the subject of the action 510, which represents the data being processed or enhanced. In the extended reality example, the subject of action 510 would be the augmented scene. In some cases, the agent 508 and subject of action 510 may be tightly integrated.

The data sources 506 may be configured to collect data used as training data 516 for the model training host 502 to train the multitask perception models. The data sources 506 may also provide inference data 512 to the model inference host 504. This data could come from various entities and may include the subject of action 510. For example, for training a multitask perception model, the data sources 506 may collect images, contextual information, and corresponding ground truth data for multiple tasks like depth estimation and semantic segmentation. The model training host 502 can then monitor the model's performance on this data to determine if retraining or fine-tuning of the shared backbone network and task-specific output heads is necessary to improve accuracy. In some cases, the agent 508 and the subject of action 510 are the same entity.

The data sources 506 may be configured for collecting data that is used as training data 516 for training the machine learning model with task-specific output heads. The data sources 506 may also provide inference data 512 (also referred to as input data) for feeding the trained model during inference. In particular, the data sources 506 may collect data relevant to multiple perception tasks, such as images for depth estimation and semantic segmentation or video frames for object detection and pose estimation. This data may come from various sources, including the subject of action 510, which represents the data being processed by the model. The collected data is provided to the model training host 502 for training and fine-tuning the multitask perception model. For example, after the subject of action 510 (e.g., an input image) is processed by the model, the output 514 (e.g., depth maps and segmentation masks) may be compared to ground truth data to evaluate the model's performance across multiple tasks. If the output 514 is not sufficiently accurate, this performance feedback may be used by the model training host 502 to further train the model using the disclosed multitask training techniques, aiming to improve its performance across all tasks. The updated model may then be deployed to the model inference host 504.

In certain aspects, the model training host 502 may be deployed at or with the same or a different entity than that in which the model inference host 504 is deployed. For example, in order to offload model training processing, which can impact the performance of the model inference host 504, the model training host 502 may be deployed at a model server as further described herein. Further, in some cases, training and/or inference may be distributed amongst devices in a decentralized or federated fashion.

In some aspects, a machine learning model utilizing task-specific output heads is deployed at or on a computing device for enhancing the performance of multiple perception tasks. More specifically, a model inference host, such as model inference host 504 in FIG. 5, may be deployed at or on the computing device for running the multitask perception model to generate multiple task-specific outputs efficiently.

In some other aspects, the multitask perception model is deployed at or on an embedded system or mobile device for enabling efficient on-device inference across multiple perception tasks. More specifically, a model inference host, such as model inference host 504 in FIG. 5, may be deployed at or on the embedded system or mobile device for running the model to obtain high-quality outputs for multiple perception tasks while meeting resource constraints.

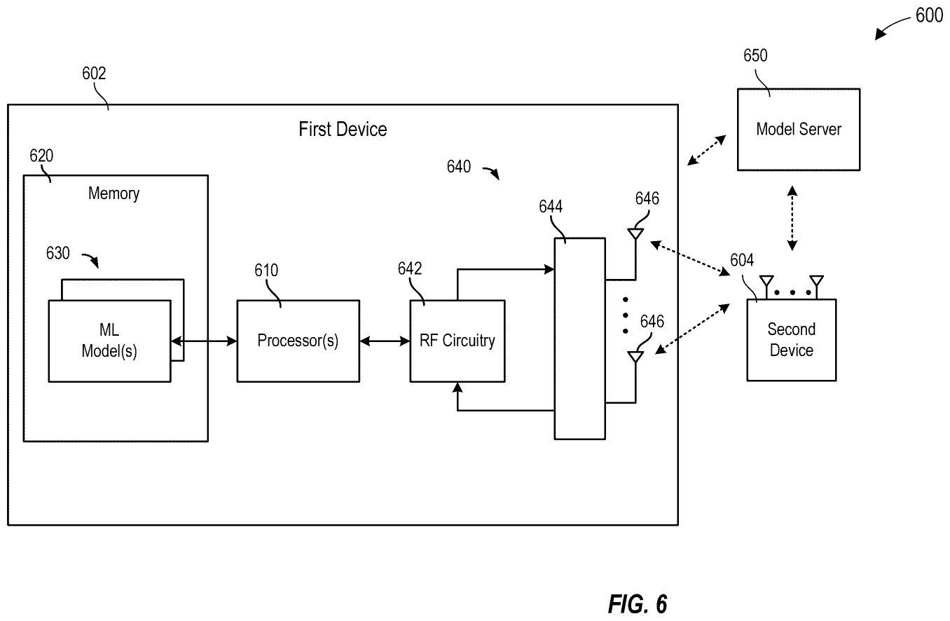

FIG. 6 illustrates an example AI architecture 600 of a first computing device 602 that is in communication with a second computing device 604. The first computing device 602 may be a server or cloud computing platform as described herein with respect to FIG. 5. Similarly, the second computing device 604 may be an embedded system or mobile device as described herein with respect to FIG. 5. Note that the AI architecture of the first computing device 602 may be applied to the second computing device 604.

The first computing device 602 may be, or may include, a chip, system on chip (SoC), a system in package (SiP), chipset, package or device that includes one or more processors, processing blocks or processing elements (collectively “the processor 610”) and one or more memory blocks or elements (collectively “the memory 620”).

As an example, in a model inference mode, the processor 610 may transform input data (e.g., images, sensor readings) into a format suitable for the multitask perception model. The processor 610 may then run the model on the formatted input data to generate multiple task-specific outputs. The processor 610 may be coupled to a transceiver 640 for transmitting the task-specific outputs to and/or receiving input data from one or more connected devices 646. The transceiver 640 includes interface circuitry 642 and 644 for converting between the digital signals of the processor and any transmission protocol used by the connected devices 646. The connected devices 646 may be sensors, actuators, displays, or storage that provide input to or consume the outputs from the model.

When receiving input data via the connected devices 646 (e.g., from the second computing device 604), the transceiver interface circuitry 642 and 644 may convert the received signals to a baseband frequency and then to digital signals for processing by the processor 610. The processor 610 may format the digital input signals and feed them into the multitask perception model for inference.

One or more ML models 630 may be stored in the memory 620 and accessible to the processor(s) 610. In certain cases, different ML models 630 with different characteristics may be stored in the memory 620, and a particular ML model 630 may be selected based on its characteristics and/or application as well as characteristics and/or conditions of first computing device 602 (e.g., a power state, a mobility state, a battery reserve, a temperature, etc.). For example, the ML models 630 may have different inference data and output pairings (e.g., different combinations of perception tasks), different levels of accuracies (e.g., 80%, 90%, or 95% accurate) associated with the predictions (e.g., the output 514 of FIG. 5), different latencies (e.g., processing times of less than 10 ms, 100 ms, or 1 second) associated with producing the predictions, different ML model sizes (e.g., file sizes), different coefficients or weights, etc.

The processor 610 may use the ML model 630 to produce output data (e.g., the output 514 of FIG. 5) based on input data (e.g., the inference data 512 of FIG. 5), for example, as described herein with respect to the inference host 504 of FIG. 5. The ML model 630 may be used to perform any of various AI-enhanced tasks, such as those listed above.

As an example, the ML model 630 may take input data and contextual information to generate multiple task-specific outputs using the multitask perception techniques previously described. The input data may include, for example, image data, point cloud data, or other sensor measurements. The output data may include, for example, multiple task-specific outputs such as depth maps, semantic segmentation masks, object detection results, and their associated confidence measures, which are obtained by applying the task-specific output heads to the shared multiscale feature representation within the model. In certain aspects, some outputs may be considered “virtual” results in that they are not directly measured but rather inferred by the model based on the input observations and the learned feature representations. In other cases, the outputs may correspond to physical quantities that are measurable in principle but not directly observed by the sensors available to the system. Note that other input data and/or output data may be used in addition to or instead of the examples described herein, depending on the specific perception tasks and the available sensors.

In certain aspects, a model server 650 may perform any of various ML model lifecycle management (LCM) tasks for the first computing device 602 and/or the second computing device 604. The model server 650 may operate as the model training host 502 and update the ML model 630 using training data. In some cases, the model server 650 may operate as the data source 506 to collect and host training data, inference data, and/or performance feedback associated with an ML model 630. In certain aspects, the model server 650 may host various types and/or versions of the ML models 630 for the first computing device 602 and/or the second computing device 604 to download.

In some cases, the model server 650 may monitor and evaluate the performance of the ML model 630 that utilizes task-specific output heads to trigger one or more lifecycle management (LCM) tasks. For example, the model server 650 may determine whether to activate or deactivate specific perception tasks at the first computing device 602 and/or the second computing device 604, based on factors such as the accuracy requirements, computational budget, and energy constraints of each device. The model server 650 may then provide instructions to the respective devices to manage their model usage accordingly. In some cases, the model server 650 may determine whether to switch to a different variant of the ML 630 at the first computing device 602 and/or the second computing device 604, based on changes in the operating conditions or performance objectives. For instance, the model server may instruct a device to switch from a complex model supporting multiple perception tasks to a simpler model focused on fewer perception tasks when the battery level falls below a threshold. In yet further examples, the model server 650 may act as a central coordinator for collaborative learning of multitask perception models across multiple devices, using techniques such as federated learning to train a global model from locally-computed updates while preserving data privacy.

### Example Artificial Intelligence Model

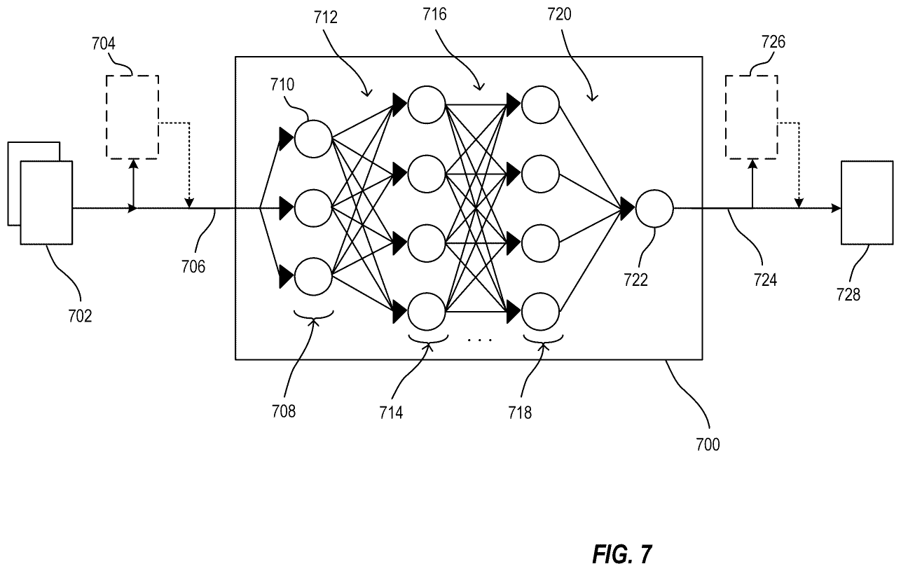

FIG. 7 is an illustrative block diagram of an example artificial neural network (ANN) 700 that can be used to implement the multitask perception techniques described in this disclosure.

ANN 700 may receive input data 706, which may include one or more bits of data 702, pre-processed data output from pre-processor 704 (optional), or some combination thereof. Here, data 702 may include sensor data from various modalities (e.g., cameras, LiDAR, radar). In some aspects, data 702 may include training data from multiple domains for domain generalization, inference data from a specific domain for domain adaptation, or the like, e.g., depending on the stage of development and/or deployment of ANN 700. Pre-processor 704 may, for example, process all or a portion of data 702 to synchronize sensor inputs, apply calibration parameters, or normalize the data. In some implementations, pre-processor 704 may add additional data to data 702, such as time stamps or sensor metadata.

ANN 700 includes at least one first layer 708 of artificial neurons 710 (e.g., perceptrons) to process input data 706 and provide resulting first layer output data via edges 712 to at least a portion of at least one second layer 714. Second layer 714 processes data received via edges 712 and provides second layer output data via edges 716 to at least a portion of at least one third layer 718. Third layer 718 processes data received via edges 716 and provides third layer output data via edges 720 to at least a portion of a final layer 722 including one or more neurons to provide output data 724. All or part of output data 724 may be further processed in some manner by (optional) post-processor 726. Thus, in certain examples, ANN 700 may provide output data 728 that is based on output data 724, post-processed data output from post-processor 726, or some combination thereof. Post-processor 726 may be included within ANN 700 in some other implementations. Post-processor 726 may, for example, process all or a portion of output data 724 which may result in output data 728 being different, at least in part, to output data 724, e.g., as result of data being changed, replaced, deleted, etc. In some implementations, post-processor 726 may be configured to add additional data to output data 724, such as domain-specific post-processing or adaptation. In this example, second layer 714 and third layer 718 represent intermediate or hidden layers that may be arranged in a hierarchical or other like structure. Although not explicitly shown, there may be one or more further intermediate layers between the second layer 714 and the third layer 718.

The structure and training of artificial neurons 710 in the various layers may be tailored to specific requirements of an application, such as multi-grid sensor fusion for object detection and tracking. Within a given layer of an ANN, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to weights and biases that may be adjusted during a training process to learn domain-invariant representations. Weights of the various artificial neurons may act as parameters to control a strength of connections between layers or artificial neurons, while biases may act as parameters to control a direction of connections between the layers or artificial neurons. An activation function may select or determine whether an artificial neuron transmits its output to the next layer or not in response to its received data. Different activation functions may be used to model different types of non-linear relationships. By introducing non-linearity into an ML model, an activation function allows the ML model to “learn” complex patterns and relationships in the input data (e.g., 512 in FIG. 5). Some non-exhaustive example activation functions include a linear function, binary step function, sigmoid, hyperbolic tangent (tanh), a rectified linear unit (ReLU) and variants, exponential linear unit (ELU), Swish, Softmax, and others.

Design tools (such as computer applications, programs, etc.) may be used to select appropriate structures for ANN 700 and a number of layers and a number of artificial neurons in each layer, as well as selecting activation functions, a loss function, training processes, etc., to enable domain generalization and adaptation. Once an initial model has been designed, training of the model may be conducted using training data from multiple domains. Training data may include one or more datasets within which ANN 700 may detect, determine, identify or ascertain patterns that are consistent across domains. Training data may represent various types of information, including written, visual, audio, environmental context, operational properties, etc., from different domains. During training, parameters of artificial neurons 710 may be changed, such as to minimize or otherwise reduce a loss function or a cost function that measures the model's performance across domains. A training process may be repeated multiple times to fine-tune ANN 700 with each iteration to improve its domain generalization capability.

Various ANN model structures are available for consideration in the context of domain generalization and adaptation. For example, in a feedforward ANN structure each artificial neuron 710 in a layer receives information from the previous layer and likewise produces information for the next layer. In a convolutional ANN structure, some layers may be organized into filters that extract domain-invariant features from data (e.g., training data and/or input data). In a recurrent ANN structure, some layers may have connections that allow for processing of data across time, such as for processing information having a temporal structure, such as time series data forecasting across domains.

In an autoencoder ANN structure, compact representations of data may be processed and the model trained to predict or potentially reconstruct original data from a reduced set of features that capture domain-invariant patterns. An autoencoder ANN structure may be useful for tasks related to dimensionality reduction and data compression in a domain-agnostic manner.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models in a domain-adaptive way. For example, a GAN could be used to generate realistic training data for a new domain to improve the domain generalization of another model.

A transformer ANN structure makes use of attention mechanisms that may enable the model to process input sequences in a parallel and efficient manner while capturing long-range dependencies and domain-specific patterns. An attention mechanism allows the model to focus on different parts of the input sequence at different times based on their relevance to the task and domain. Attention mechanisms may be implemented using a series of layers known as attention layers to compute, calculate, determine or select weighted sums of input features based on a similarity between different elements of the input sequence. A transformer ANN structure may include a series of feedforward ANN layers that may learn non-linear relationships between the input and output sequences in a domain-adaptive way. The output of a transformer ANN structure may be obtained by applying a linear transformation to the output of a final attention layer. A transformer ANN structure may be of particular use for tasks that involve sequence modeling, or other like processing, across different domains.

Another example type of ANN structure, is a model with one or more invertible layers. Models of this type may be inverted or “unwrapped” to reveal the input data that was used to generate the output of a layer, which can be useful for understanding how the model adapts to different domains.

Other example types of ANN model structures that can be used for domain generalization and adaptation include fully connected neural networks (FCNNs) and long short-term memory (LSTM) networks.

ANN 700 or other ML models may be implemented in various types of processing circuits along with memory and applicable instructions therein, for example, as described herein with respect to FIGS. 5 and 6. For example, general-purpose hardware circuits, such as, such as one or more central processing units (CPUs) and one or more graphics processing units (GPUs) may be employed to implement a model. One or more ML accelerators, such as tensor processing units (TPUs), embedded neural processing units (eNPUs), or other special-purpose processors, and/or field-programmable gate arrays (FPGAs), application-specific integrated circuits (ASICs), or the like also may be employed. Various programming tools are available for developing ANN models that can perform object detection.

### Aspects of Artificial Intelligence Model Training

There are a variety of model training techniques and processes that may be used prior to, or at some point following, deployment of an ML model, such as ANN 700 of FIG. 7.

For example, training data may include synchronized sensor data from multiple modalities and ground truth annotations of objects in various environments. This data can be used to train the model to accurately provide task-specific outputs. In certain instances, the training data may originate from real-world scenarios, simulation environments, or a combination of both. The training data collection process can be performed offline, resulting in a static dataset for batch training, or online, where new samples are continuously incorporated into the model training pipeline. For offline training, data collection and model updates can occur at a central location (e.g., a datacenter) or be distributed across multiple nodes (e.g., a network of cameras). For online training, the model may be adapted locally on each device or by a remote server that receives streaming data from the devices.

In certain instances, all or part of the training data may be shared within a communication system, or even shared (or obtained from) outside of the communication system.

Once an ML model has been trained with training data from multiple domains, its performance may be evaluated on held-out test data from both seen and unseen domains. In some scenarios, evaluation/verification tests may use a validation dataset, which may include data not in the training data, to compare the model's performance to baseline or other benchmark information across different domains. If model performance is deemed unsatisfactory, it may be beneficial to fine-tune the model, e.g., by changing its architecture, re-training it on the data with domain-specific adjustments, or using different optimization techniques that promote domain generalization, etc. Once a model's performance is deemed satisfactory across a wide range of domains, the model may be deployed accordingly. In certain instances, a model may be updated in some manner, e.g., all or part of the model may be changed or replaced, or undergo further training with data from new domains, just to name a few examples.

As part of a training process for an ANN, such as ANN 700 of FIG. 7, parameters affecting the functioning of the artificial neurons and layers may be adjusted to learn domain-invariant representations. For example, backpropagation techniques may be used to train the ANN by iteratively adjusting weights and/or biases of certain artificial neurons associated with errors between a predicted output of the model and a desired output that may be known or otherwise deemed acceptable across different domains. Backpropagation may include a forward pass, a loss function, a backward pass, and a parameter update that may be performed in training iteration. The process may be repeated for a certain number of iterations for each set of training data until the weights of the artificial neurons/layers are adequately tuned to minimize domain-specific biases.

Backpropagation techniques associated with a loss function may measure how well a model is able to predict a desired output for a given input across different domains. An optimization algorithm may be used during a training process to adjust weights and/or biases to reduce or minimize the loss function which should improve the performance of the model on unseen domains. There are a variety of optimization algorithms that may be used along with backpropagation techniques or other training techniques to promote domain generalization. Some initial examples include a gradient descent based optimization algorithm and a stochastic gradient descent based optimization algorithm. A stochastic gradient descent (or ascent) technique may be used to adjust weights/biases in order to minimize or otherwise reduce a loss function that measures cross-domain performance. A mini-batch gradient descent technique, which is a variant of gradient descent, may involve updating weights/biases using a small batch of training data from different domains rather than the entire dataset. A momentum technique may accelerate an optimization process by adding a momentum term to update or otherwise affect certain weights/biases in a domain-agnostic way.

An adaptive learning rate technique may adjust a learning rate of an optimization algorithm associated with one or more characteristics of the training data from different domains. A batch normalization technique may be used to normalize inputs to a model in order to stabilize a training process and potentially improve the performance of the model across domains.

A “dropout” technique may be used to randomly drop out some of the artificial neurons from a model during a training process, e.g., in order to reduce overfitting to specific domains and potentially improve the generalization of the model to unseen domains.

An “early stopping” technique may be used to stop an on-going training process early, such as when a performance of the model using a validation dataset from a different domain starts to degrade.

Another example technique includes data augmentation to generate additional training data by applying domain-specific transformations to all or part of the training information.

A transfer learning technique may be used which involves using a pre-trained model as a starting point for training a new model on a different domain, which may be useful when training data from the new domain is limited or when there are multiple tasks that are related to each other across domains.

A multitask learning technique may be used which involves training a model to perform multiple tasks simultaneously across different domains to potentially improve the performance of the model on one or more of the tasks in a domain-agnostic way. Hyperparameters or the like may be input and applied during a training process in certain instances to control the degree of domain generalization.

Another example technique that may be useful with regard to an ML model for domain generalization is some form of a “pruning” technique. A pruning technique, which may be performed during a training process or after a model has been trained, involves the removal of unnecessary (e.g., because they have no impact on the output) or less necessary (e.g., because they have negligible impact on the output), or possibly redundant features from a model. In certain instances, a pruning technique may reduce the complexity of a model or improve efficiency of a model without undermining the intended performance of the model across different domains.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may need to be transmitted or stored, while preserving its domain generalization capability.

Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In certain aspects, pruning techniques also may be applied to training data, e.g., to remove outliers, etc. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting, or otherwise improve the performance of the trained model.

One or more of the example training techniques presented above may be employed as part of a training process. As above, some example training processes that may be used to train an ML model include supervised learning, unsupervised learning, semi-supervised learning, and reinforcement learning technique.

Decentralized, distributed, or shared learning, such as federated learning, may enable training of machine learning models that utilize task-specific output heads on data distributed across multiple devices or organizations, without the need to centralize the data or the training process. Federated learning is particularly useful when the training data is sensitive or subject to privacy constraints, or when it is impractical, inefficient, or expensive to gather all the data in one place. In the context of multitask perception, for example, federated learning may be used to improve model performance by allowing it to learn from a wide range of environments and conditions. For instance, a multitask perception model may be trained on data collected from a large number of smartphones or autonomous vehicles, each with its own sensor configuration and operating domain, to improve its robustness and generalization across multiple perception tasks. With federated learning, each device may receive a copy of the model and perform local training using its own data to capture device-specific patterns. The devices then send only the updated model parameters (e.g., weights and biases) to a central server, without revealing the raw data. The server aggregates the contributions from all devices and updates the global model, which is then redistributed to the devices for the next round of local training. This process is repeated iteratively until the multitask perception model achieves satisfactory performance across all participating devices and tasks. By enabling collaborative learning while keeping data localized, federated learning allows the development of powerful multitask perception models that can leverage diverse datasets without compromising privacy or security.

In some implementations, one or more devices or services may support processes relating to the usage, maintenance, activation, and reporting of machine learning models that utilize task-specific output heads. In certain instances, all or part of the training data or the trained model may be shared across multiple devices to provide or improve the multitask perception capabilities. For example, a smartphone with multiple sensors may share its data with a smartphone having limited sensors, enabling the latter to train a multitask perception model using shared feature representations. In some cases, signaling mechanisms may be employed to communicate the capabilities and requirements for performing specific functions related to multitask perception models, such as the supported input and output formats, the available computational resources, or the ability to collect and share training data. These models may be used to support various applications, such as augmented reality, robotics, autonomous driving, or video processing, where simultaneous understanding of multiple aspects of the scene (depth, segmentation, object detection) is important. The deployment of multitask perception models may occur at different levels of a system architecture, such as on individual devices (e.g., smartphones, vehicles), edge servers (e.g., base stations, access points), or cloud platforms, depending on factors such as latency requirements, data privacy concerns, and resource availability. By leveraging the multitask perception techniques, these models can provide high-quality outputs for multiple perception tasks while operating under the constraints of each deployment scenario.

### Example Operations for Performing Multitask Perception Techniques

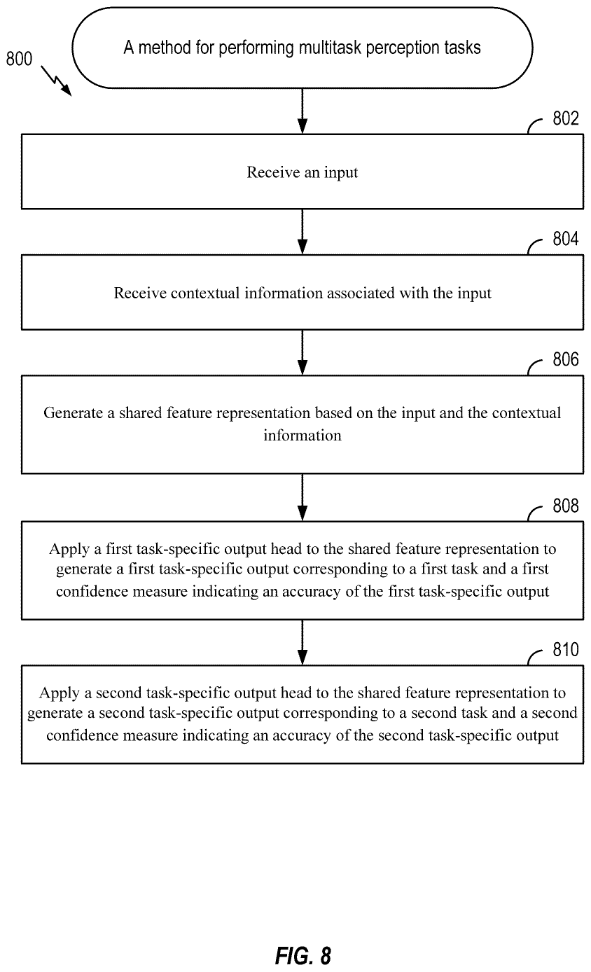

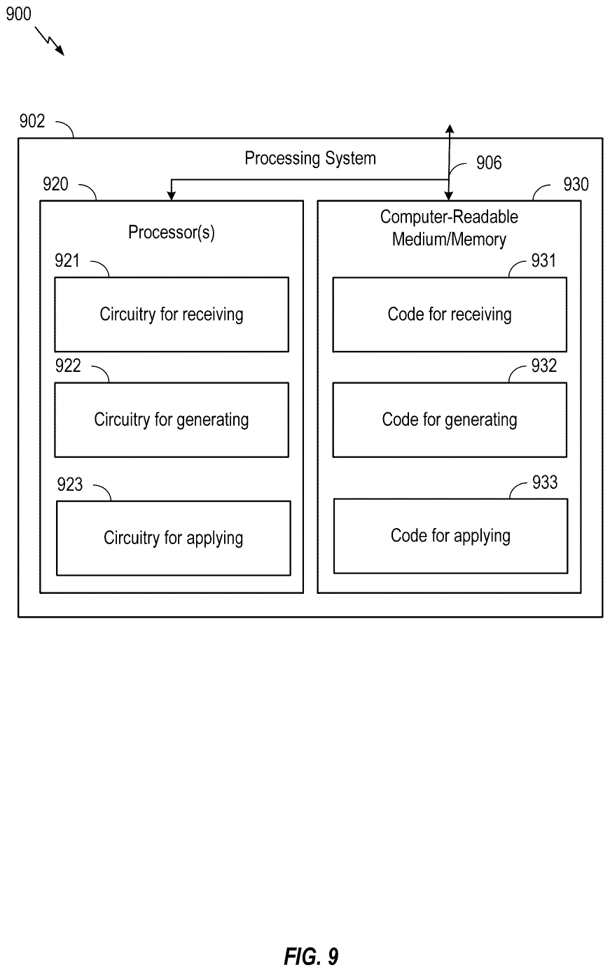

FIG. 8 depicts an example method 800 for performing multitask perception techniques. In one aspect, method 800 can be implemented by the system (e.g., system 100 of FIG. 1 or the multitask perception model 202 of FIG. 2) and/or a processing system 900 of FIG. 9. For example, the operations of method 800 may leverage the shared backbone network 108, shared feature fusion component 110, and shared multiscale feature representations 107 as described in FIG. 1, and the usage of contextual and validation information as described in FIGS. 1-4. By applying one or more task-specific output heads depicted in FIG. 1 (e.g., first task-specific perception head 112 and second task-specific perception head 122) to the shared multiscale feature representation 107, the method 800 may simultaneously generate multiple perception task outputs and associated confidence measures.

Method 800 starts at block 802 with receiving an input. For example, the received input may correspond to input 102 (FIG. 1).

Method 800 continues to block 804 with receiving contextual information associated with the input. For example, the received contextual information may correspond to the contextual information 104 (FIG. 1) which may include parameters, partial ground truth data, or pseudo-contextual information. In some aspects, the contextual information may correspond to the contextual validation information 204 (FIG. 2).

Method 800 continues to block 806 with generating a shared feature representation based on the input and the contextual information. For example, the shared backbone network backbone network 108 of FIGS. 1-2 may generate the shared feature representation based on the input and the contextual information.

Method 800 continues to block 808 with applying a first task-specific output head to the shared multiscale feature representation to generate a first task-specific output corresponding to a first task and a first confidence measure indicating an accuracy of the first task-specific output. For example, the first task-specific perception head 112 may generate task-specific outputs 116 and 120 with task-specific output heads 114, 118 as depicted in FIG. 1. In some aspects, the shared feature representation may be a shared multiscale feature representation generated by a shared feature fusion component.

Method 800 continues to block 810 with applying a second task-specific output head to the shared multiscale feature representation to generate a second task-specific output corresponding to a second task and a second confidence measure indicating an accuracy of the second task-specific output. For example, the second task-specific perception head 122 may generate task-specific outputs 126 and 128 with a task-specific output head 124, as depicted in FIG. 1. In some aspects, the shared feature representation may be a shared multiscale feature representation generated by a shared feature fusion component.

In some aspects, separate machine learning models may be implemented for each perception task, leading to increased computation, memory usage, latency, and power consumption. In some aspects, method 800 may utilize a shared backbone network and a shared feature fusion component (as depicted in FIG. 1 and FIG. 2) to generate a shared multiscale feature representation. In some aspects, the shared multiscale feature representation may support multiple perception tasks simultaneously. In some aspects, task-specific output heads may perform their respective perception tasks without needing entirely separate models, reducing computational redundancy, lowering memory footprints, and improving processing speed.

Note that FIG. 8 is just one example of a method, and other methods including fewer, additional, or alternative operations are possible consistent with this disclosure.

In one aspect, method 800, or any aspect related to it, may be performed by an apparatus, such as processing system 900 of FIG. 9, which includes various components operable, configured, or adapted to perform the method 800.

Note that FIG. 8 is just one example of a method, and other methods including fewer, additional, or alternative steps are possible consistent with this disclosure.

### Example Processing System for Performing Multitask Perception Techniques

FIG. 9 depicts aspects of an example processing system 900.

The processing system 900 includes a processing system 902 includes one or more processors 920. The one or more processors 920 are coupled to a computer-readable medium/memory 930 via a bus 906. In certain aspects, the computer-readable medium/memory 930 is configured to store instructions (e.g., computer-executable code) that when executed by the one or more processors 920, cause the one or more processors 920 to perform the method 700 described with respect to FIG. 7, or any aspect related to it, including any additional steps or sub-steps described in relation to FIG. 7.

In the depicted example, computer-readable medium/memory 930 stores code 931 (e.g., executable instructions) for receiving an input and/or for receiving contextual information, code 932 for generating a shared feature representation based on the input and the contextual information, and code 933 for applying a first task-specific output head to the shared multiscale feature representation to generate a first task-specific output corresponding to a first task and a first confidence measure indicating an accuracy of the first task-specific output and/or for applying a second task-specific output head to the shared multiscale feature representation to generate a second task-specific output corresponding to a second task and a second confidence measure indicating an accuracy of the second task-specific output. Processing of the code 931-933 may enable and cause the processing system 900 to perform the method 800 described with respect to FIG. 8, or any aspect related to it.

The one or more processors 920 include circuitry configured to implement (e.g., execute) the code stored in the computer-readable medium/memory 930, including circuitry 921 for receiving an input and/or for receiving contextual information, circuitry 922 for generating a shared feature representation based on the input and the contextual information, multiscale, and circuitry 923 for applying a first task-specific output head to the shared multiscale feature representation to generate a first task-specific output corresponding to a first task and a first confidence measure indicating an accuracy of the first task-specific output and/or for applying a second task-specific output head to the shared multiscale feature representation to generate a second task-specific output corresponding to a second task and a second confidence measure indicating an accuracy of the second task-specific output. Processing with circuitry 921-923 may enable and cause the processing system 900 to perform the method 800 described with respect to FIG. 8, or any aspect related to it.

### Example Clauses

Implementation examples are described in the following numbered clauses:

Clause 1: A method for performing multitask perception tasks, the method comprising: receiving an input; receiving contextual information associated with the input; generating a shared feature representation based on the input and the contextual information; applying a first task-specific output head to the shared feature representation to generate a first task-specific output corresponding to a first task and a first confidence measure indicating an accuracy of the first task-specific output; and applying a second task-specific output head to the shared feature representation to generate a second task-specific output corresponding to a second task and a second confidence measure indicating an accuracy of the second task-specific output.

Clause 2: The method according to Clause 1, wherein the input comprises image data, and the contextual information comprises one or more reference data points derived from depth measurements associated with the image data.

Clause 3: The method according to any one of Clauses 1-2, wherein the first task-specific output corresponds to a depth estimation task, and the second task-specific output corresponds to a segmentation task, wherein the segmentation task is configured to classify portions of the input into respective semantic categories.

Clause 4: The method according to any one of Clauses 1-3, wherein the contextual information provides one or more parameters to determine at least one of the first task-specific output or the second task-specific output.

Clause 5: The method according to Clause 4, wherein the contextual information comprises one or more reference data points, labels, or values that, when combined with the input, provide at least one of a known scale, constraint, or boundary condition used to determine at least one of the first task-specific output or the second task-specific output.

Clause 6: The method according to any one of Clauses 1-5, wherein generating the shared feature representation based on the input and the contextual information comprises generating, by a shared backbone network, the shared feature representation, wherein the shared backbone network comprises a convolutional neural network based backbone, and the first and second task-specific output modules each comprise at least one respective neural network layer to generate a respective output and confidence measure.

Clause 7: The method according to any one of Clauses 1-6, further comprising: receiving contextual validation information indicating an accuracy of one or more portions of the contextual information; and adjusting a weighting of the one or more portions of the contextual information based on the contextual validation information.

Clause 8: The method according to any one of Clauses 1-7, wherein generating the shared feature representation comprises generating, by a shared feature fusion component, the shared feature representation, wherein the shared feature fusion component comprises: a plurality of reassembly blocks configured to organize features at different spatial scales; and a plurality of fusion blocks configured to integrate features across the different spatial scales to generate a shared multiscale feature representation.

Clause 9: The method according to any one of Clauses 1-8, wherein the contextual information comprises: pseudo-contextual information generated by a model; and ground truth data, wherein the one or more processors are further configured to use the ground truth data to adjust the pseudo-contextual information.

Clause 10: The method according to any one of Clauses 1-9, further comprising: refining at least one of the first task-specific output or the second task-specific output based on their respective confidence measures.

Clause 11: The method according to any one of Clauses 1-10, wherein each of the first confidence measure and the second confidence measure indicates a respective accuracy of the corresponding task-specific output at different spatial locations within the input.

Clause 12: The method according to any one of Clauses 1-11, wherein generating the shared feature representation comprises generating, by a shared backbone network and a shared feature fusion component, the shared feature representation.

Clause 13: The method according to Clause 12, further comprising: determining a first loss based on the first task-specific output; determining a second loss based on the second task-specific output; and updating one or more parameters of at least one of the shared backbone network, the shared feature fusion component, the first task-specific output head, or the second task-specific output head based on the first loss and the second loss.

Clause 14: The method according to any one of Clauses 12-13, wherein the shared backbone network comprises an architecture adapted to extract features, and the shared feature fusion component is configured to integrate the extracted features across multiple scales and abstraction levels.

Clause 15: The method according to any one of Clauses 12-14, wherein the shared feature representation is a multiscale feature representation.

Clause 16: One or more apparatuses, comprising: one or more memories comprising executable instructions; and one or more processors configured to execute the executable instructions and cause the one or more apparatuses to perform a method in accordance with any one of clauses 1-15.

Clause 17: One or more apparatuses, comprising: one or more memories; and one or more processors, coupled to the one or more memories, configured to cause the one or more apparatuses to perform a method in accordance with any one of Clauses 1-15.

Clause 18: One or more apparatuses, comprising: one or more memories; and one or more processors, coupled to the one or more memories, configured to perform a method in accordance with any one of Clauses 1-15.

Clause 19: One or more apparatuses, comprising means for performing a method in accordance with any one of Clauses 1-15.

Clause 20: One or more non-transitory computer-readable media comprising executable instructions that, when executed by one or more processors of one or more apparatuses, cause the one or more apparatuses to perform a method in accordance with any one of Clauses 1-15.

Clause 21: One or more computer program products embodied on one or more computer-readable storage media comprising code for performing a method in accordance with any one of Clauses 1-15.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus, comprising a processing system including one or more processors and one or more memories coupled with the one or more processors, the processing system configured to cause the apparatus to:
receive an input;
receive contextual information associated with the input;
generate a shared feature representation based on the input and the contextual information;
apply a first task-specific output head to the shared feature representation to generate a first task-specific output corresponding to a first task and a first confidence measure indicating an accuracy of the first task-specific output; and
apply a second task-specific output head to the shared feature representation to generate a second task-specific output corresponding to a second task and a second confidence measure indicating an accuracy of the second task-specific output.

2. The apparatus of claim 1, wherein the input comprises image data, and the contextual information comprises one or more reference data points derived from depth measurements associated with the image data.

3. The apparatus of claim 1, wherein the first task-specific output corresponds to a depth estimation task, and the second task-specific output corresponds to a segmentation task, wherein the segmentation task is configured to classify portions of the input into respective semantic categories.

4. The apparatus of claim 1, wherein the contextual information provides one or more parameters to determine at least one of the first task-specific output or the second task-specific output.

5. The apparatus of claim 4, wherein the contextual information comprises one or more reference data points, labels, or values that, when combined with the input, provide at least one of a known scale, constraint, or boundary condition used to determine at least one of the first task-specific output or the second task-specific output.

6. The apparatus of claim 1, wherein to generate the shared feature representation based on the input and the contextual information comprises to generate, by a shared backbone network, the shared feature representation, wherein the shared backbone network comprises a convolutional neural network based backbone, and the first and second task-specific output modules each comprise at least one respective neural network layer to generate a respective output and confidence measure.

7. The apparatus of claim 1, wherein the processing system is configured to cause the apparatus to:
receive contextual validation information indicating an accuracy of one or more portions of the contextual information; and
adjust a weighting of the one or more portions of the contextual information based on the contextual validation information.

8. The apparatus of claim 1, wherein to generate the shared feature representation comprises to generate, by a shared feature fusion component, the shared feature representation, wherein the shared feature fusion component comprises:
a plurality of reassembly blocks configured to organize features at different spatial scales; and
a plurality of fusion blocks configured to integrate features across the different spatial scales to generate a shared multiscale feature representation.

9. The apparatus of claim 1, wherein the contextual information comprises:
pseudo-contextual information generated by a model; and
ground truth data,
wherein the one or more processors are further configured to use the ground truth data to adjust the pseudo-contextual information.

10. The apparatus of claim 1, wherein processing system is configured to cause the apparatus to: refine at least one of the first task-specific output or the second task-specific output based on their respective confidence measures.

11. The apparatus of claim 1, wherein each of the first confidence measure and the second confidence measure indicates a respective accuracy of the corresponding task-specific output at different spatial locations within the input.

12. The apparatus of claim 1, wherein to generate the shared feature representation comprises to generate, by a shared backbone network and a shared feature fusion component, the shared feature representation.

13. The apparatus of claim 12, wherein the processing system is configured to cause the apparatus to:
determine a first loss based on the first task-specific output;
determine a second loss based on the second task-specific output; and
update one or more parameters of at least one of the shared backbone network, the shared feature fusion component, the first task-specific output head, or the second task-specific output head based on the first loss and the second loss.

14. The apparatus of claim 12, wherein:
the shared backbone network comprises an architecture adapted to extract features, and
the shared feature fusion component is configured to integrate the extracted features across multiple scales and abstraction levels.

15. The apparatus of claim 12, wherein the shared feature representation is a multiscale feature representation.

16. A method for performing multitask perception tasks, comprising:
receiving an input;
receiving contextual information associated with the input;
generating a shared feature representation based on the input and the contextual information;
applying a first task-specific output head to the shared feature representation to generate a first task-specific output corresponding to a first task and a first confidence measure indicating an accuracy of the first task-specific output; and
applying a second task-specific output head to the shared feature representation to generate a second task-specific output corresponding to a second task and a second confidence measure indicating an accuracy of the second task-specific output.

17. The method of claim 16, wherein the input comprises image data, and the contextual information comprises one or more reference data points derived from depth measurements associated with the image data.

18. The method of claim 16, wherein the first task-specific output corresponds to a depth estimation task, and the second task-specific output corresponds to a segmentation task, wherein the segmentation task is configured to classify portions of the input into respective semantic categories.

19. The method of claim 16, wherein the contextual information provides one or more parameters to determine at least one of the first task-specific output or the second task-specific output.

20. The method of claim 19, wherein the contextual information comprises one or more reference data points, labels, or values that, when combined with the input, provide at least one of a known scale, constraint, or boundary condition used to determine at least one of the first task-specific output or the second task-specific output.
